(19) United States
(12) Patent Application Publication
(10) Pub. No.: US 2013/0100671 A1
(43) Pub. Date: Apr. 25, 2013

(54) ALUMINUM BASE BOARD WITH THE HEAT RELEASING PORTION

(71) Applicant: Chao-Chuan CHEN, Taichung City (TW)

(72) Inventor: Chao-Chuan CHEN, Taichung City (TW)

(21) Appl. No.: 13/278,180

(22) Filed: Oct. 21, 2011

(51) Int. Cl. F21V 29/00; F21V 21/00

(52) U.S. Cl. 362/249.02

(57) ABSTRACT

An aluminum base board with the heat releasing portion includes a base board made with aluminum and multiple holes are defined through the base board. At least one LED is connected to the base board and partially covers the holes. Therefore, the heat of the at least one LED is transferred to the base board and the heat of the base board is released to the air efficiently via the holes.

### BACKGROUND OF THE INVENTION

1. Field of the Invention

The present invention relates to an aluminum base board with the heat releasing portion, and more particularly to an aluminum base board with the heat releasing portion for releasing heat generated from Light Emitting Diode.

2. Description of Related Art

Light Emitting Diode (LED) has high efficiency for transferring electric energy into light energy and has longer life time so that LED are used in everyday life such as street lights, home lights, business lights and backlight modules. Unfortunately, a part of the electric energy used for the LED is transferred into the heat energy, and if too much heat energy is trapped around the LED, the life time and stability of the LED is decreasing.

A conventional heat releasing base board is designed to overcome the above shortcomings of the LED. The conventional heat releasing base board might be made with the materials such as silver, copper, aluminum, steel or alloy . . . etc, wherein the most popular material for the heat releasing is the aluminum alloy. However, the conventional heat releasing base board still has one shortcoming as following:

The conventional heat releasing base board does not further consider that the heat can be released by the way of convection and conduction.

The present invention has arisen to mitigate and/or obviate the disadvantages of the conventional. Further benefits and advantages of the present invention will become apparent after a careful reading of the detailed description with appropriate reference to the accompanying drawings.

### SUMMARY OF THE INVENTION

The main objective of the present invention is to provide an improved aluminum base board.

To achieve the objective, an aluminum base board with the heat releasing portion comprises a base board made with aluminum and multiple holes defined through the base board, at least one LED connected to the base board and partially covering the holes, the holes filled with a heat conductive material, the heat conductive material being nano carbon, heat conductive plastic or heat conductive paste.

Wherein, the heat of the at least one LED is transferred to the base board and the heat of the base board is released to the air efficiently via the holes.

The aluminum base board with the heat releasing portion comprises a base board made with aluminum and having a heat dispensing portion formed on the bottom thereof, at least one LED connected to the top of the base board, the heat dispensing portion having multiple recesses and a heat conductive material covering the heat dispensing portion and filling in the recesses, the heat conductive material being heat conductive plastic or heat conductive paste.

Wherein, the heat of the at least one LED is transferred to the base board and the heat of the base board is released to the air efficiently via the heat conductive material.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of an aluminum base board with the heat releasing portion for showing the arrangement of the first embodiment;

FIG. 2 is a perspective view for showing an LED connected to the aluminum base board with the heat releasing portion of the first embodiment;

FIG. 3 is a cross-sectional view of the aluminum base board with the heat releasing portion of the first embodiment along the line A-A shown in FIG. 2;

FIG. 4 is a perspective view for showing the LED connected to the aluminum base board with the heat releasing portion of the second embodiment;

FIG. 5 is a cross-sectional view of the aluminum base board with the heat releasing portion of the second embodiment along the line A-A shown in FIG. 4;

FIG. 6 is a perspective view of the aluminum base board with the heat releasing portion for showing the arrangement of the third embodiment;

FIG. 7 is a cross-sectional view of the aluminum base board with the heat releasing portion of the third embodiment along the line A-A shown in FIG. 6;

FIG. 8 is a perspective view for showing the LED connected to the aluminum base board with the heat releasing portion of the third embodiment; and

FIG. 9 is a cross-sectional view of the aluminum base board with the heat releasing portion of the third embodiment along the line A-A shown in FIG. 8.

### DETAILED DESCRIPTION OF THE INVENTION

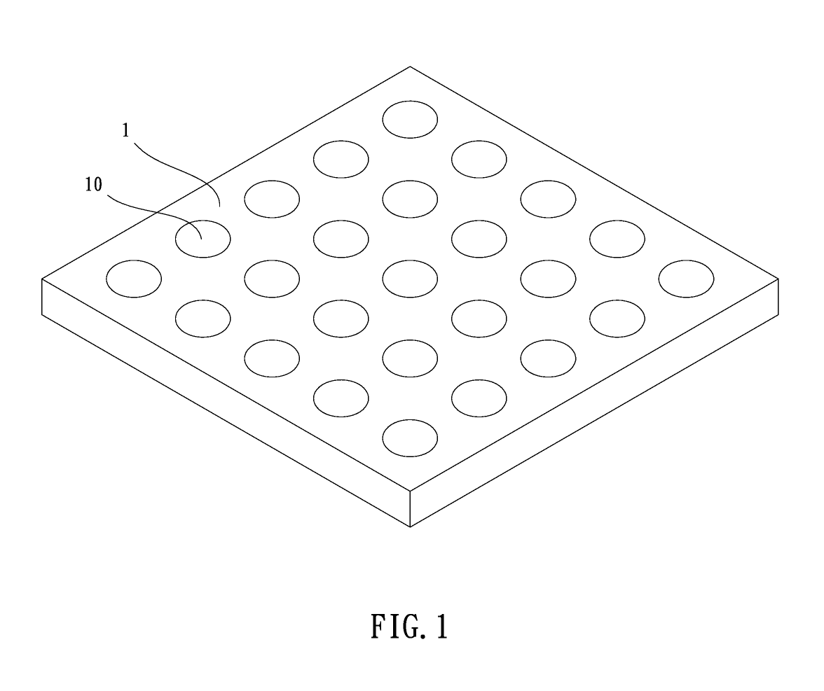

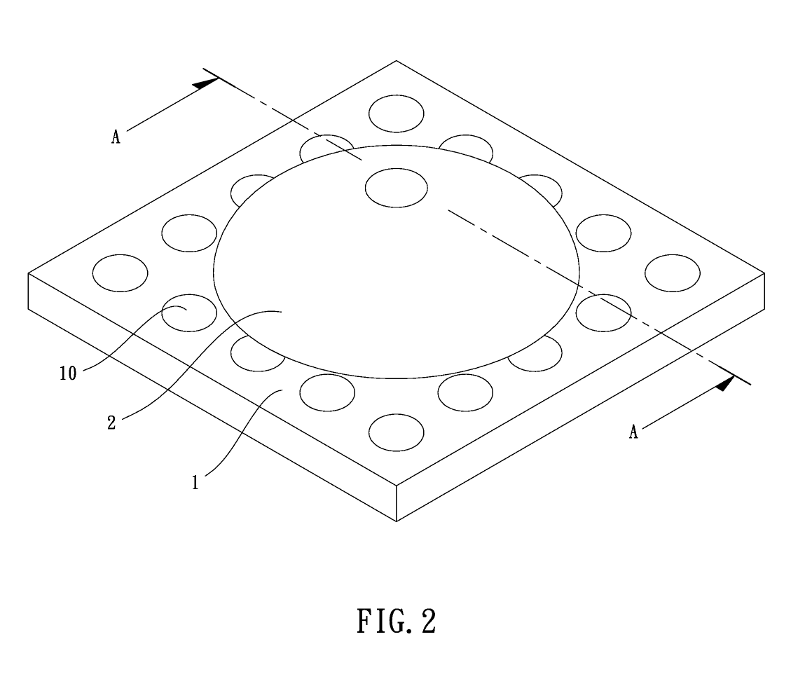

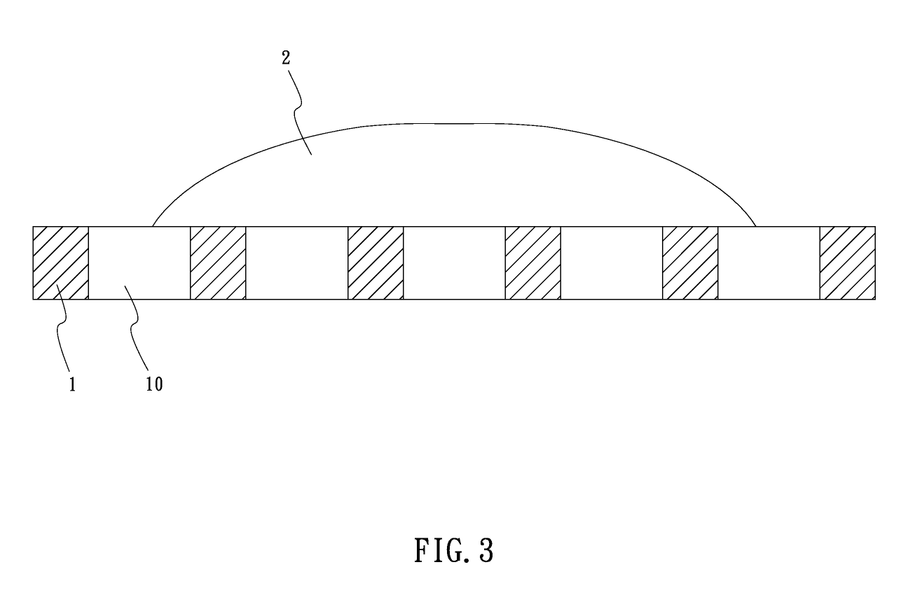

Referring to FIGS. 1-3, an aluminum base board with the heat releasing portion in accordance with the present invention comprises a base board 1, multiple holes 10 and at least one LED 2 (Light Emitting Diode).

The base board 1 is made with aluminum and the multiple holes 10 are defined through the base board 1. The at least one LED 2 is connected to the base board 1 and partially covers the holes 10. The base board 1 is made with aluminum alloy which has high heat conductive coefficient and is suitable for being machined. The at least one LED 2 transfers the electric energy into the light energy and the heat. Because the heat from the LED 2 is accumulating, when the temperature of the at least one LED 2 is brought from 25 degrees Celsius to 100 degrees Celsius, the illumination efficiency might decay from 20% to 75% itself The at least one LED 2 releases the heat by way of convection and heat conduction, wherein the convection uses air flow as an agent which brings the high temperature air to the low temperature air so that the heat from the LED 2 is brought to the low temperature air via the air flow; the conduction uses the base board 1 attached to the LED 2 as an agent, which has the lower temperature than the temperature of the LED 2 and brings the heat from the LED 2 to the base board 1 itself The holes 10 on the base board 1 increase the contact area between the base board 1 and the air so as to release the heat of the base board 1 to the air via convection efficiently so that the temperature of the base board 1 is kept lower than the temperature of the LED 2. Under this arrangement, one part of the heat of the LED 2 is transmitted to the air via the convection; another part of the heat of the LED 2 is transmitted to the base board 1 via conduction and is further transmitted from the base board 1 to the air via the convection. Therefore, the temperature of the LED 2 is falling down.

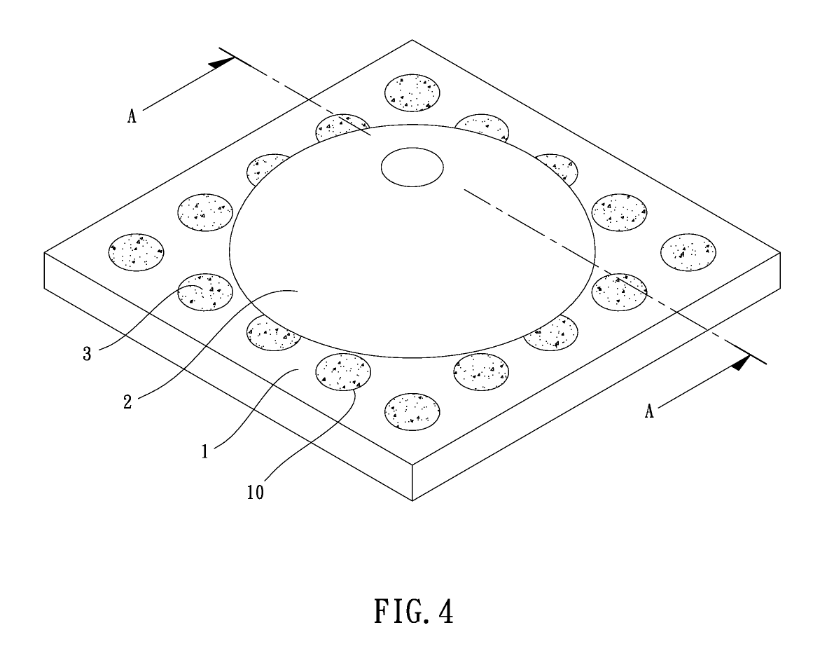

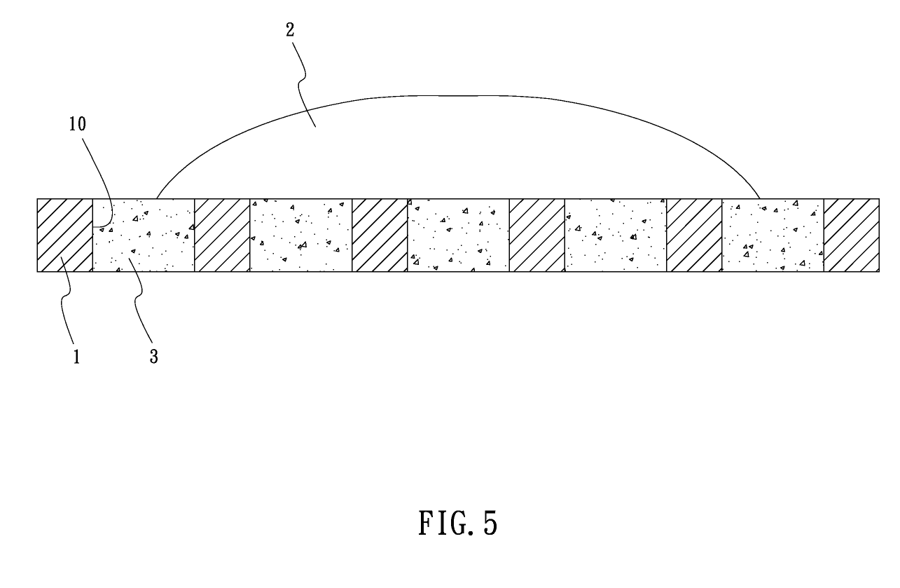

As shown in FIGS. 4 and 5 of the second embodiment, each hole 10 on the base board 1 is filled with a heat conductive material 3. The heat conductive material 3 might be nano carbon, heat conductive plastic or heat conductive paste. The heat conduction coefficient of the heat conductive plastic or heat conductive paste is 0.5 W/mK to 1.5 W/mK. The heat conduction coefficient of the common conductive material 3 is in a range between 0.5 W/mK to 20 W/mK and is a low thermal resistance and electric isolation material. The nano carbon is high heat conductive and transfers heat energy into light energy, and the heat is dispensed by way of infrared radiation. The contact surface and the air that contacts the heat source may affect the thermal resistance. The heat conductive material 3 fills the holes 10 to increase the efficiency for releasing heat from the base board 1.

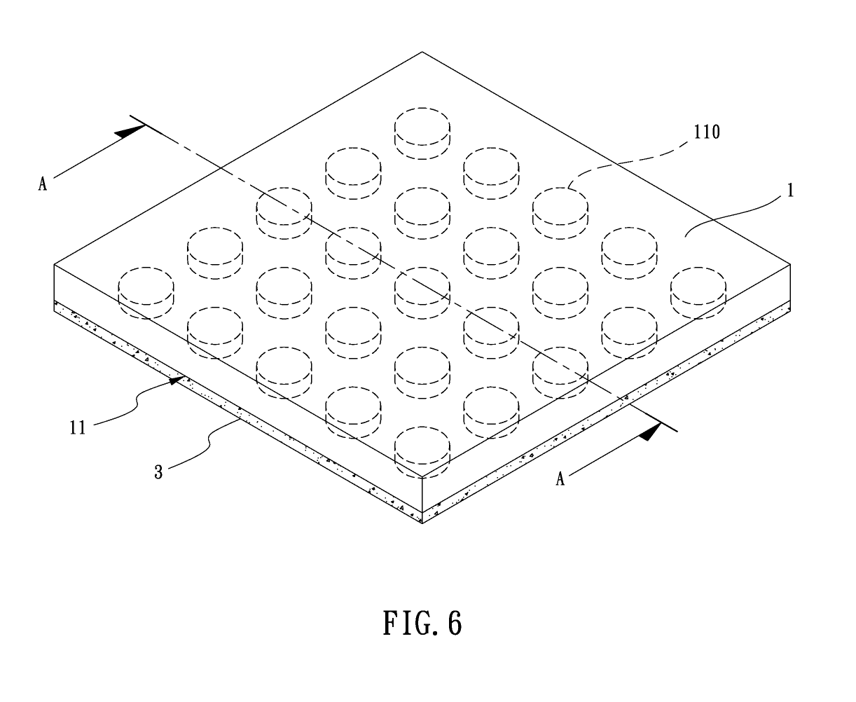

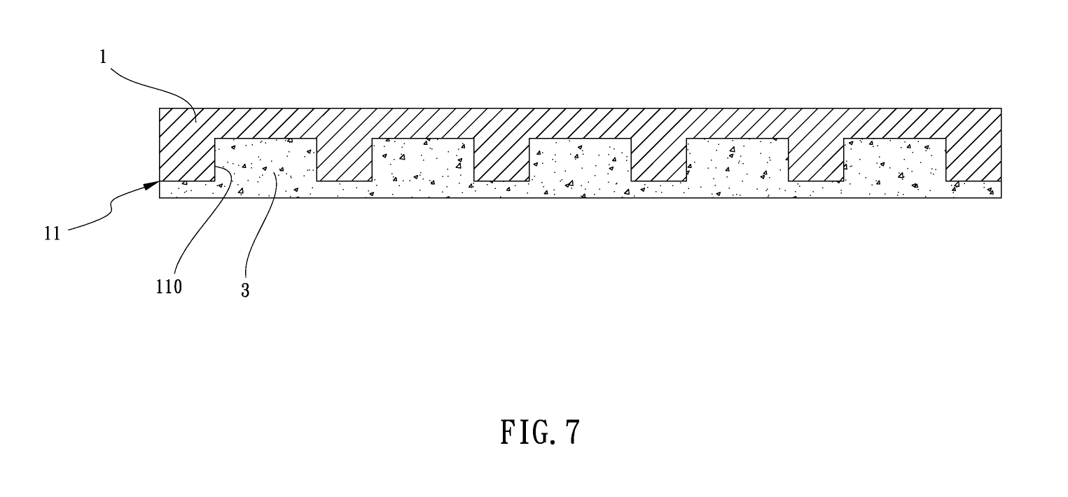

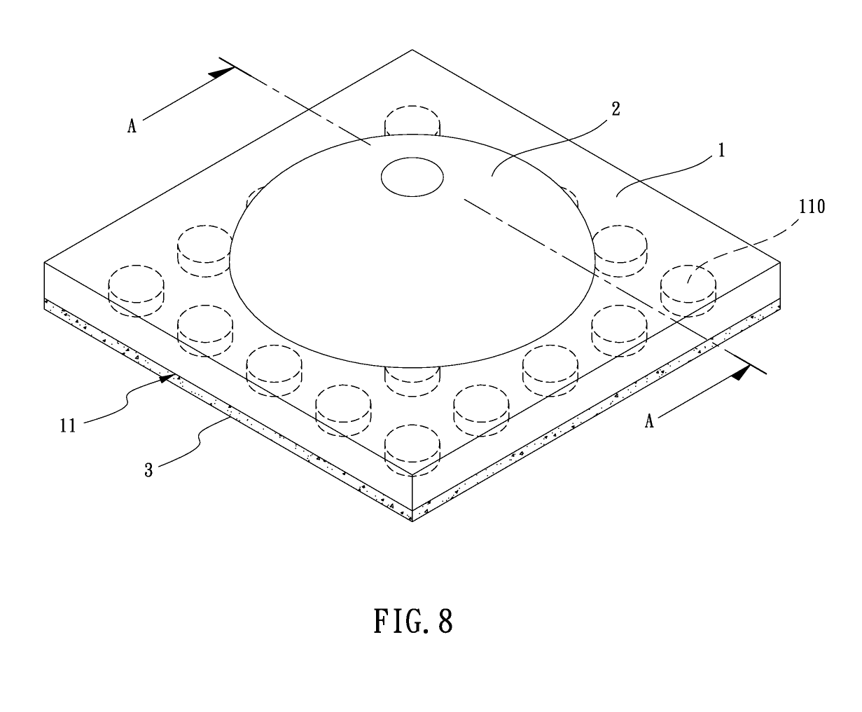

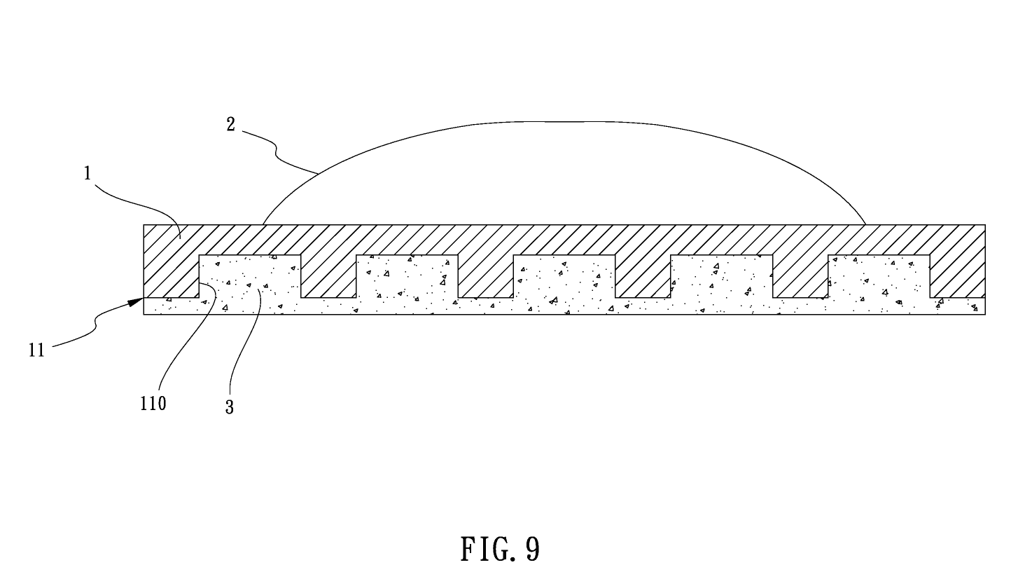

Referring to FIGS. 6-9 of the third embodiment, the aluminum base board with the heat releasing portion in accordance with the present invention comprises the base board 1 made with aluminum, a heat dispensing portion 11 formed on the bottom of the base board 1 and at least one LED 2 connected to the top of the base board 1. The heat dispensing portion 11 has multiple recesses 110 and the heat conductive material 3 covers the heat dispensing portion 11 and fills in the recesses 110. In the third embodiment, the heat conductive material 3 is the heat conductive plastic or the heat conductive paste. The heat of the at least one LED 2 is transferred to the base board 1. The recesses 110 increases the contact area between the heat dispensing portion 11 and the heat conductive material 3 so as to transfer the heat of the base board 1 from the heat dispensing portion 11 to the heat conductive material 3 efficiently. The heat conductive material 3 covering the heat dispensing portion 11 increases the contact area between the heat conductive material 3 and the air so as to transfer the heat of the heat conductive material 3 to the air efficiently. Therefore, the temperature of the LED 2 is falling down.

The recesses 110 and the heat dispensing material 3 uses the ways of conduction and convection to bring heat away from the LED 2 to ensure that the LED is operated as desired.

Although the invention has been explained in relation to its preferred embodiment, it is to be understood that many other possible modifications and variations can be made without departing from the spirit and scope of the invention as hereinafter claimed.

What is claimed is:

1. An aluminum base board with the heat releasing portion comprising:
a base board made with aluminum and multiple holes defined through the base board; and
at least one LED connected to the base board and partially covering the holes;
wherein, the heat of the at least one LED is transferred to the base board and the heat of the base board is released to the air efficiently via the holes.

2. The aluminum base board with the heat releasing portion as claimed in claim 1, wherein the holes are filled with heat conductive material.

3. The aluminum base board with the heat releasing portion as claimed in claim 2, wherein the heat conductive material is nano carbon.

4. The aluminum base board with the heat releasing portion as claimed in claim 2, wherein the heat conductive material is heat conductive plastic.

5. The aluminum base board with the heat releasing portion as claimed in claim 2, wherein the heat conductive material is heat conductive paste.

6. The aluminum base board with the heat releasing portion comprising:
a base board made with aluminum and having a heat dispensing portion formed on the bottom thereof and at least one LED connected to the top of the base board; and
the heat dispensing portion having multiple recesses and a heat conductive material covering the heat dispensing portion and filling in the recesses;
wherein, the heat of the at least one LED is transferred to the base board and the heat of the base board is released to the air efficiently via the heat conductive material.

7. The aluminum base board with the heat releasing portion as claimed in claim 6, wherein the heat conductive material is heat conductive plastic.

8. The aluminum base board with the heat releasing portion as claimed in claim 6, wherein the heat conductive material is heat conductive paste.
